(19) United States
(12) Patent Application Publication
(10) Pub. No.: US 2017/0228433 A1
(43) Pub. Date: Aug. 10, 2017

(54) METHOD AND SYSTEM FOR DIVERSE SET RECOMMENDATIONS

(71) Applicant: Microsoft Technology Licensing, LLC, Redmond, WA (US)

(72) Inventors: Charles M. GARTRELL, Herzlia (IL); Ulrich PAQUET, Cambridge (GB); Noam KOENIGSTEIN, RaAnana (IL); Nir NICE, Kfar-Vradim (IL)

(21) Appl. No.: 15/015,291

(22) Filed: Feb. 4, 2016

(51) Int. Cl. G06F 17/30; G06N 99/00; G06F 3/0482

(52) U.S. Cl. CPC G06F 17/30528; G06F 17/3056; G06F 3/0482; G06N 99/005

(57) ABSTRACT

A system and method for basket completion for items contained in a catalog, uses the determinantal point process on a closed set of items in a catalog. A parameter space contains the items of the catalog as vectors of parameters whose values are obtained using the determinantal point process in a learning process. Subsequently a user input obtains a selection from a user of one or more items from the catalogue. Then a selector selects another item within the parameter space whose vector forms a largest area when combined with the vectors of the already present items. The large area implies both popularity of the item and complementarity of the new item with the items already chosen. The user is provided with the new item to complete a basket with the already present items.

### BACKGROUND

Recommendation systems are a key discovery experience. Recommendations are often presented to a user as a set of recommended items displayed together on one screen. While much prior work on recommendation systems focuses on computing predictions for individual items, some work does address the problem of set recommendation, in which a person has already selected one or more items and the idea is to recommend one or more additional items that complement the item already selected. Balancing item quality and diversity is a key aspect of set recommendation. Set recommendation is useful for identifying additional documents relevant to a search or for selecting tools for a task, or for selecting complementary products, including assisting users with finding further books or music based on books or music already selected.

Existing solutions to set recommendation include use of association rules and an association classifier. The existing solutions generally lack a way to jointly maximize item quality and diversity in recommended sets. That is to say, there are solutions that may select other items with an association of some kind with the first item, and other solutions that may select other items of high quality. However the current solutions do not identify the item that optimizes for maxima in both quality and diversity at the same time. Furthermore, many previous solutions lack efficient mechanisms for learning and other important inference tasks and also tend to lack scalability.

### SUMMARY

The present embodiments may provide a system and method for basket completion for items contained in a closed list, which uses the determinantal point process on a closed set of items in the closed list, for example a catalog of consumer products, books, music, tools and the like. A learning process uses a parameter space and defines the items of the catalog as vectors within the space in terms of parameters whose values are obtained using the determinantal point process (DPP). Each vector is seeded with seed values for the parameters, and the values are optimized over the learning process based on actual sets of items selected. Subsequently a user input obtains a selection from a user of one or more items from the catalogue. Then a selector selects another item within the parameter space whose vector forms a largest area when combined with the vectors of the already present items. The large area implies both popularity and quality of the item on the one hand and complementarity of the new item with the items already chosen on the other hand. The user is provided with the new item to complete a basket with the already present items.

While DPPs have been known in the research community for some time, the present embodiments are an application of DPPs to the specific and concrete problem of basket completion.

The present embodiments may provide a parameterization of the DPP model for set recommendation that learns latent item traits such that item quality and diversity are jointly maximized. Embodiments may further include a scalable algorithm, and an algorithm for DPP parameter learning. The embodiments may provide the use of the parameterized DPP model for basket completion.

While the algorithm is general, the present embodiments relate to the specific and concrete application to the case of a closed catalog of items and completion of baskets of items chosen by users to provide products that complement the items already chosen and are of similar quality.

Unless otherwise defined, all technical and/or scientific terms used herein have the same meaning as commonly understood by one of ordinary skill in the art. Although methods and materials similar or equivalent to those described herein can be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the disclosure are herein described, by way of example only, with reference to the accompanying drawings. With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

In the drawings:

FIG. 1 is a simplified block diagram showing a system according to the present embodiments;

FIG. 2 is a simplified flow chart showing operation of a learning phase according to the present embodiments;

FIG. 3 is a simplified flow chart showing operation of a selection or use phase according to the present embodiments;

FIG. 4 is a simplified diagram showing a set of six consumer products as vectors embedded in a parameter space according to the present embodiments;

FIG. 5 is a simplified diagram showing geometrical representations of the determinant of a matrix and illustrating how the determinant of a matrix formed from the vectors of multiple items can be used to indicate the quality and popularity of the items as well as indicating how well they complement each other, according to the present embodiments; and

FIG. 6 is a simplified diagram showing an item catalog and training data as well as a learned DPP kernel, according to the present embodiments.

### DETAILED DESCRIPTION

The present embodiments may provide a system and method for basket completion for items contained in a closed list, for example a catalog of items. The system may use the determinantal point process on the closed set of items in the catalog. A parameter space contains the items of the catalog as vectors, and the vectors contain values for each parameter for each item. Values for the parameters are obtained using the determinantal point process in a learning process. Subsequently a user input obtains a selection from a user of one or more items from the catalogue. Then a selector selects another item within the parameter space whose vector forms a largest area when combined with the vectors of the already present items. The large area implies both popularity of the item and complementarity of the new item with the items already chosen. The user is provided with the new item to complete a basket with the already present items.

As explained above, the present embodiments may utilize a probabilistic model for set recommendation, based on a model called the Determinantal Point Process (DPP), which seeks to jointly maximize both the diversity and quality of items within a recommended set. Efficient algorithms exist for inference tasks in DPPs, including sampling and conditioning. Using a DPP parameterization for set recommendation and an efficient optimization algorithm for parameter learning, the present embodiments may learn an embedding of items in a latent item trait space. While DPPs have been known in the research community for some time, the present embodiments apply DPPs to the problem of set completion and the specific and concrete problem of basket completion to complement already chosen items.

Previous solutions to set recommendation generally lack a principled way to jointly maximize item quality and diversity in recommended sets. Furthermore, many previous solutions lack efficient mechanisms for learning and other important inference tasks. In contrast, an implementation according to the present embodiments may provide a principle solution for jointly maximizing item quality and diversity, and may further provide an efficient and scalable algorithm for learning in our model.

The present embodiments may be applicable to any domain where set recommendation and basket completion would be useful.

For example, the present embodiments may be applicable to generate recommendations to complete a basket of movies, TV programs, music, and applications found in an app store, or a basket of consumer products, or sets of tools to complete a task. The present embodiments may provide basket completion, wherein the user provides a basket of items, e.g., {A, B, C}, and the present embodiments may recommend an item D to complete this basket.

Before explaining at least one embodiment of the exemplary embodiments in detail, it is to be understood that the disclosure is not necessarily limited in its application to the details of construction and the arrangement of the components and/or methods set forth in the following description and/or illustrated in the drawings and/or the Examples. The disclosure is capable of other embodiments or of being practiced or carried out in various ways.

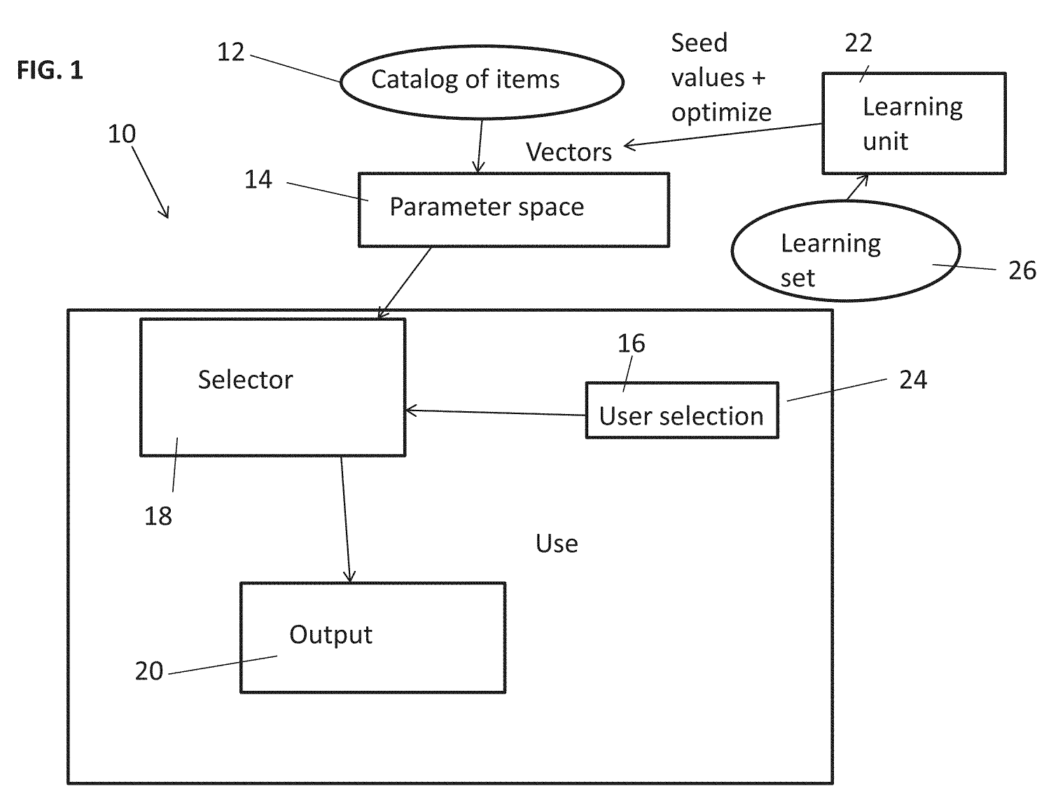

Referring now to the drawings, FIG. 1 illustrates a system for basket completion for items contained in a closed list such as a catalog of items. The system may be implemented over an electronic network such as the Internet and uses an electronic processor. As shown in FIG. 1, the system 10 includes catalog of items 12. The items may be tools for a particular task, or items of equipment, or items for sale etc. Catalog 12 is a closed group of items in the sense that items not explicitly in the catalog are not part of the group. Items may be added to the catalog at any time, but at any given time the group is limited to the items explicitly in the catalog.

The items in the catalog are represented by values to a set of parameters in a parameter space 14. The parameter space may for example be four or six dimensional so that each item takes its own set of values for each of the four or six parameters. The values for each item define a vector within the parameter space, so that the catalogue is represented as a series of vectors within the parameter space. The series of vectors may be formed into a matrix having the number of parameters as a first dimension and a number of items in the catalog as the second dimension. The way in which the values are obtained will be discussed hereinbelow.

Once the matrix is set up for the catalog 12, then user input 16 accepts a selection from a user of one or more items chosen from the catalog 12. The user selection contains items from the catalog with particular parameters, and the aim is to provide the user with other items that complement the items already chosen. For example the user may be looking for a set of tools to complete a particular task, and the system may be able to suggest to the user other tools that complement the tools already chosen, or other equipment that can be used with the tools chosen, or is needed for the tools chosen. In other examples the user may have chosen certain items of music and the system may suggest other items of music that complement the music already chosen.

To this end there is provided a selector 18 whose task it is to select another item within the parameter space whose vector forms a largest area when combined with the vector of the already selected items. The large area indicates on the one hand that the item is popular and of good quality, and also indicates that it complements the original item, as will be explained in greater detail below.

An output 20 provides the user with the selection, thereby completing the user's basket of items. The output may provide the suggestion as a message, or may provide the suggestion by actually dispatching the physical item, depending on the specific implementation.

The system may comprise a learning unit 22 and a use unit 24. The learning unit 22 provides the vectors which describe the items in the catalog by setting initial seed values into each vector and then using an existing learning set 26 made of user selected baskets of the items in the catalog and optimizing the parameters so that the areas defined by the matrices of the user baskets are maximized As will be explained below, the result may be achieved by maximizing the determinants of matrices formed from sets of items actually obtained by users.

By contrast, the user input 16, the selector 18 and the output 20 are part of the use unit 24, which makes use of the vectors from the parameter space 14 after optimization by the learning unit 22.

It is noted that the use unit 24 may reoptimize the matrix during the use phase. That is to say the parameters may be updated based on baskets actually chosen by users. Thus the system is able to take account of changing tastes and respond to particular items becoming more highly regarded and other items going out of favor.

The selector 18 obtains the selection as discussed by finding the vector which, when added to the existing item vector, provides a largest area. The item may be found by calculating the determinant of an item matrix formed by the vectors in the selection.

The process used by the learning unit to calculate the parameters for the items by finding values which maximize the determinant of a matrix formed from the selected items is the determinantal point process, as mentioned above, and the use unit 26 is configured to calculate the largest area using the parameters obtained from the determinantal point process.

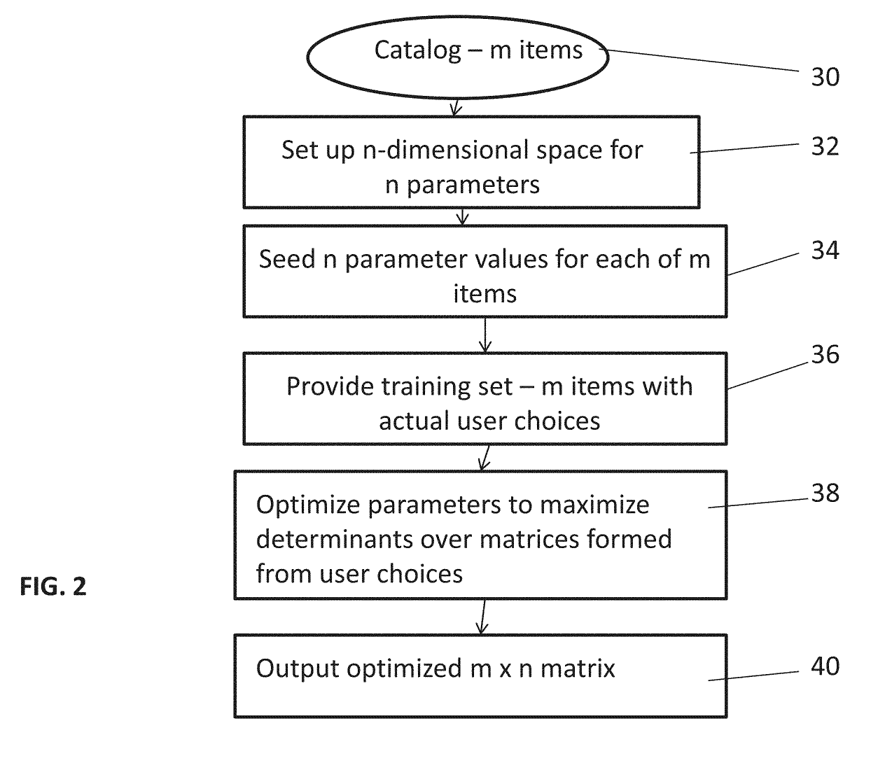

Reference is now made to FIG. 2 which is a simplified flow chart illustrating the learning phase of the present embodiments. A catalog of m items is obtained 30 and an n-dimensional parameter space is set up 32 to describe each catalog item using n parameters. Each catalog item is then provided with n seed values for the parameters 34. A training set is then provided—36—of actual user selections so that if users think that items A and B are of good quality and A goes with item B then items A and B may be expected to appear fairly frequently as common members of user selections. If users think that items A and B are not of high quality but belong together then they will appear rarely but will appear together. Likewise if A is popular but B not, if B is popular but A not, and if neither A nor B are popular.

The training process then goes through the training set to optimize 38 the parameters in such a way as to maximize the determinants of the matrices formed by actual user selections. Finally the resulting optimized n×m matrix for the n parameters and m items in the catalog is provided as the output of the training process —40.

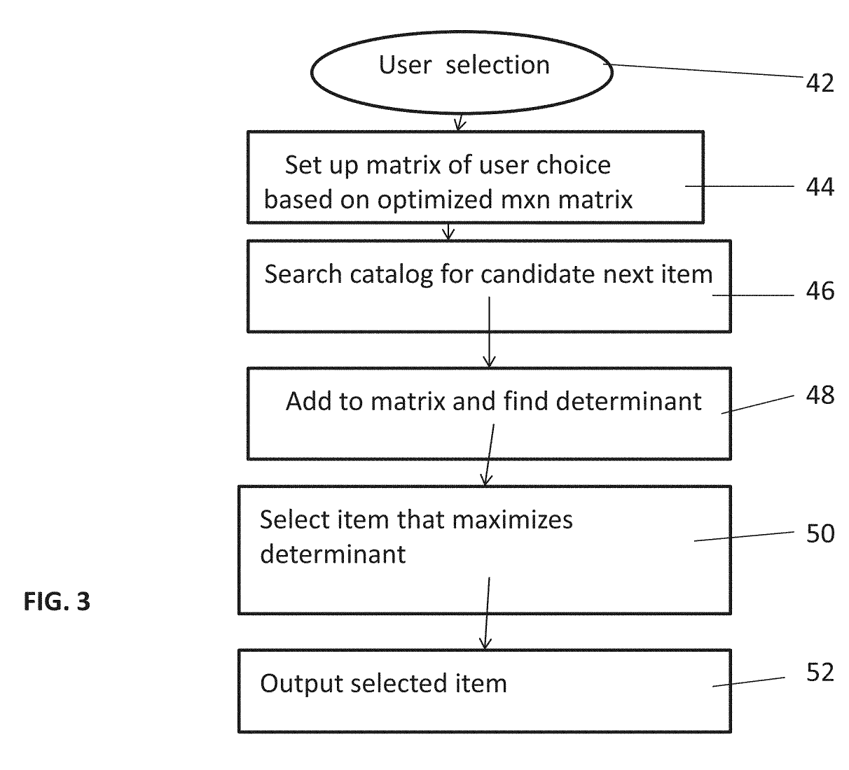

Reference is now made to FIG. 3 which is a simplified flow chart illustrating a process for selecting a recommendation to complete a basket chosen by a user, according to the present embodiments.

In the embodiment of FIG. 3, a user selection of some items from the catalog is received 42. The optimized m×n matrix from the learning stage is consulted and a selection matrix is obtained of the vectors of the user-selected items—44. The catalog is then searched—46—for candidate complementary additional items. Each item is added one by one—48—to the selection matrix and a determinant is calculated. The larger the determinant the greater probability that the item belongs and the item whose determinant with the other items already chosen provides the highest probability is selected—50—and output—52—to the end user.

The present embodiments are now considered in greater detail. The embodiments provide an original and specific use in a real world application for the determinant point process (DPP) and use of the DPP allows for basket completion on a larger scale than existing solutions. Whereas existing basket completion solutions are cubic in the catalog size, the present solution is cubic in the selection size, providing speeds of some twenty times faster in typical applications. The improvements apply both to the training and use phases, although the improvements are different.

An advantage of DPP is that the basket completion process is entirely mathematical, going directly from users' actual choices to the recommendation with no issue of bias entering into the system.

DPP was tried against existing basket completion algorithms and was found not only to be quicker but also a better predictor of missing items in the baskets.

The DPP methodology is based on the matrix determinant, as explained above. The value of the determinant is the volume spanned by the parallelogram made by the matrix. Large vectors indicate popular or good quality items, and dissimilar items that are often seen together in a selection generally are optimized to have a large angle between them. Popular or good quality items get through the optimization process with bigger vectors than unpopular items or low quality items. As a result, items that are both popular and generally selected together get through the optimization process with vectors which when combined with each other give a shape with a large area or volume. Similar or unpopular items produce vectors that combine to produce small areas or volumes. Hence, two popular items that are selected together will tend to be distinguished by a large volume spanned by the corresponding matrix and thus a large determinant.

The optimization process in fact learns traits of the items. Given V is the set of optimized values, one may obtain a relatively large matrix L=VV^{T} and it is possible to use a lower dimensional matrix that is easier to learn, as will be discussed below. The V matrix of optimized values is the output of the learning phase.

Selection of the additional item for basket completion involves finding the probability of the set y including already selected items and the candidate item. The probability for the candidate set y is given by:

$${P}_{L} ( y ) = \frac{det ( Ly )}{det ( L + 1 )} \qquad ( 1 )$$

In the above, I is identity matrix, and Ly is the matrix defining set y. In other words, y is the intersection of the y items in the L matrix, one of which is the candidate item and the remainder are the items already selected. A probability is obtained by dividing the determinants

The probability is the probability that is fed back into the model every time a candidate full basket is suggested. The det (L+1) part of the probability is constant as long as the catalog and the parameter values remain the same so that the finding of the probability P_{L}(y) effectively amounts to finding the determinant of Ly.

Updates may be made as new user selections are encountered. Updates may be made to the V matrix itself by modifying the parameter values. Alternatively, it may be possible to do stochastic updating as new data is received in real time.

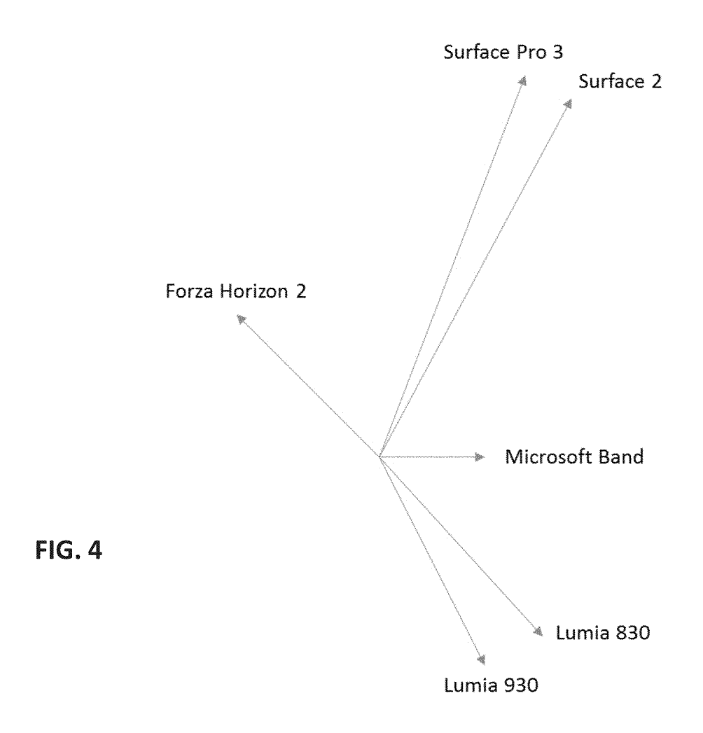

Reference is now made to FIG. 4 which illustrates some vectors that may result from the learning phase for certain items. The learning phase may use an efficient algorithm to learn an embedding of items in a latent trait space given set observations. An embodiment may seek to jointly maximize set diversity and quality, as explained. Specifically, FIG. 4 illustrates an embedding of item trait vectors of six mobile communication related items, where the trait vectors are learned by the DPP model and projected into a parameter space. In FIG. 4, the magnitude (length) of an item's trait vector indicates the quality/popularity of an item. The angle between two item trait vectors indicates how similar these items are to each other. In the figure it is apparent that the Microsoft Band is less popular than the other items in the catalog, that the Surface 3 Pro is similar to the Surface 2, and that the Lumia 830 is similar to the Lumia 930. The model learns these patterns by observing sets (baskets) of items that are purchased together, as explained.

### Model Description

A model according to the present embodiments may learn a M×K matrix V, which is a matrix composed of latent traits for M items and K item trait dimensions. We have an M×M matrix L=VV^{T}, where Lᵢⱼ=Σₖ₌₁^{K}vᵢₖvⱼₖ.The log likelihood f for seeing N sets A={Aₙ} is:

$$f ( V ) = log p ( A \vert V ) = {\sum }_{n = 1}^{N} log p ( {A}_{n} \vert V ) = {\sum }_{n = 1}^{N} log \vert {L}_{[ n ]} \vert - N log \vert L + 1 \vert \qquad ( 2 )$$

where [n] indexes the observations in Aₙ. To learn the parameters V, one may maximize the log-likelihood function. One can then generate new set recommendations by sampling from a DPP defined by these parameters, or by computing an estimate of the most probable set. Furthermore, to perform the basket completion of the present embodiments, one can condition a DPP on the event that some items in a basket are already observed (e.g., {A, B, C}) and ask the DPP to recommend the next item that should be added to the basket. The present algorithms may construct such a conditioned DPP as discussed herein.

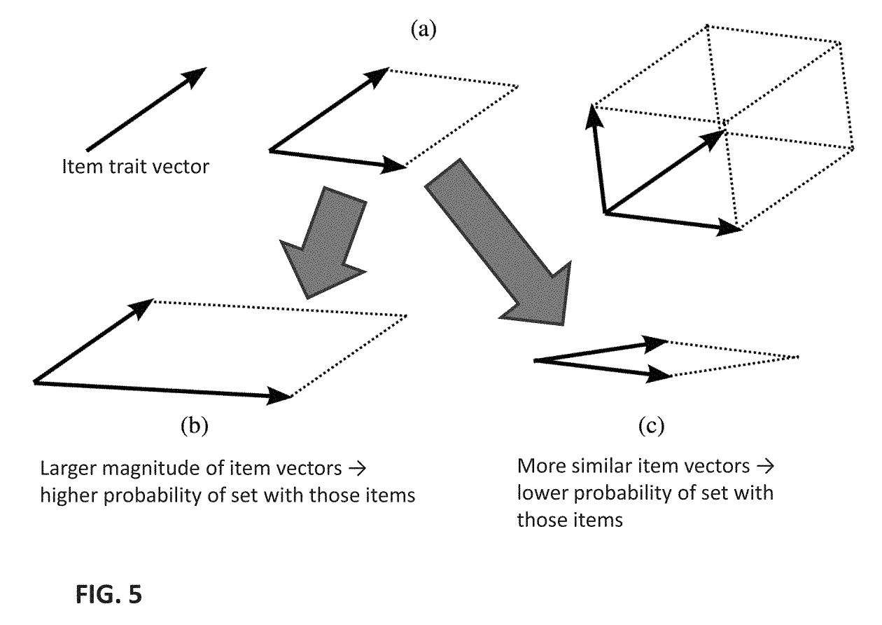

Reference is now made to FIG. 5, which illustrates the determinant as a geometric function of the combined vectors. A concept in DPPs is the determinant, which appears in the likelihood function above. As shown in FIG. 5, the determinant has a geometric interpretation that results in higher probability for diverse sets containing high quality or more popular items. The probability of a set being recommended is the square of the volume spanned by the item trait vectors for the items contained in that set. Thus, as the magnitude of an item's trait vector (approximately equivalent to the quality of the item) increases, the probability of a recommended set containing that item increases, as shown in part (b) of FIG. 5. Additionally, as the similarity between two items increases, the angle between their trait vectors decreases, and the probability of a recommended set containing those items decreases, as shown in part (c) of FIG. 5. Therefore, from the geometric interpretation of DPPs, it may be observed that diverse sets are more probable because their item trait vectors are more orthogonal and thus span larger volumes. High quality items (items with large-magnitude trait vectors) are also more likely to appear, since they increase the volume for sets containing these items.

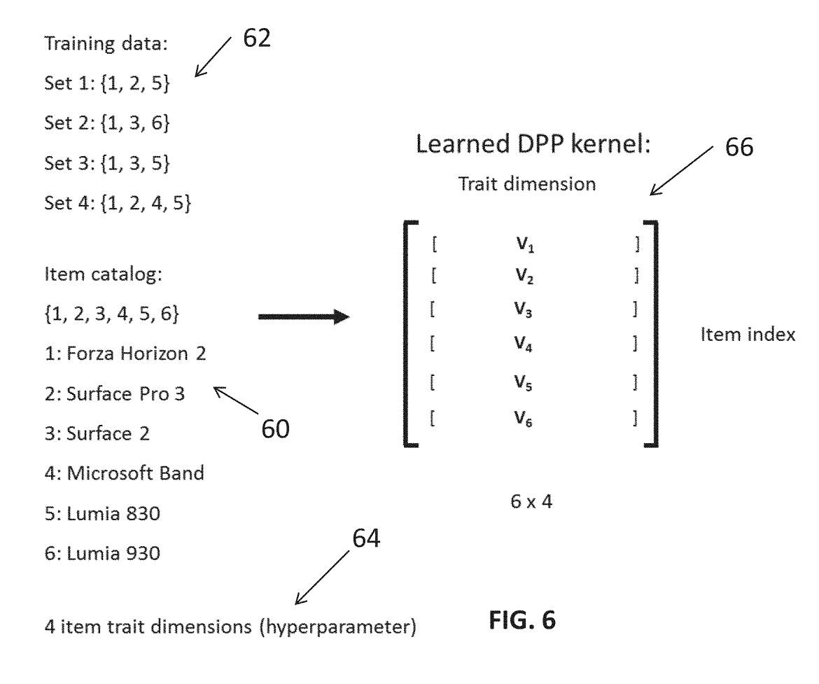

The present embodiments are illustrated with a simplified example of DPP learning in FIG. 6. In the example, an item catalog 60 comprises six different items 1 . . . 6 from a store. We observe four sets (baskets) 1 . . . 4 of items purchased by users to be used as training data 62. The model designer may select four item trait dimensions as a hyperparameter 64 to use in the DPP model. The present embodiments learn a kernel matrix of parameters that embeds the items in a latent item trait space such that item diversity and quality (popularity) are jointly maximized given the observed data. Based on the observed data and the properties of the model, items which are not popular, such as the Microsoft Band, have a low probability of appearing in recommended sets. Sets containing similar items, such as the Surface Pro 3 and Surface 2, have a low probability of being recommended. Conversely, sets containing diverse and popular items, such as Forza Horizon 2 and the Lumia 830, are more likely to be recommended. The trait vectors learned for each item are contained within the learned DPP kernel matrix 66, which has a dimension of the number items in the catalog multiplied by the hyperparameter, in this example 6×4.

The learning process is now described in greater detail. The learning task is to fit a DPP kernel L based on a collection of N observed subsets A={A1, . . . , An} composed of items from the item catalog Y. These observed subsets A constitute the training data, and the task is to maximize the likelihood for data samples drawn from the same distribution as A.

The log-likelihood for seeing A is:

$$\begin{matrix}f ( V ) = log p ( A \vert V ) = {\sum }_{n = 1}^{N} log p ( An \vert V ) & ( 3 ) \\ = {\sum }_{n = 1}^{N} log det ( L [ n ] ) - N l og det ( L + I ) & ( 4 )\end{matrix}$$

where [n] indexes the observations or objects in A. We call the log-likelihood function f, to avoid confusion with the matrix L. As stated above, L=VVT. The following describes how to perform optimization and regularization for learning the DPP kernel.

### Optimization Algorithm

We determine the V matrix by gradient ascent. Therefore, we want to quickly compute the derivative δf/δV, which may be an M×_K matrix. For i ∈ 1 . . . M and k ∈ 1 . . . K, we need a matrix of scalar derivatives:

$${\{ \frac{δ f}{δ V} \}}_{ik} = \frac{\partial f}{\partial {v}_{ik}}$$

Taking the derivative of each term of the log-likelihood, we have:

$$\begin{matrix}\frac{\partial f}{\partial {v}_{ik}} = {\sum }_{n \text{:} i ∈ [ n ]} \frac{\partial }{\partial {v}_{ik}} ( log det ( {L}_{[ n ]} ) ) - N \frac{\partial }{\partial {v}_{ik}} ( log det ( L + I ) ) \\ = {\sum }_{n \text{:} i ∈ [ n ]} tr ( {L}_{[ n ]}^{- 1} \frac{\partial {L}_{[ n ]}}{\partial {v}_{ik}} ) - Ntr ( {( L + I )}^{- 1} \frac{\partial ( L + I )}{\partial {v}_{ik}} ) .\end{matrix} \qquad ( 5 )$$

To compute the_first term of the derivative, we see that:

$$tr ( {L}_{[ n ]}^{- 1} \frac{\partial {L}_{[ n ]}}{\partial {v}_{ik}} ) = {a}_{i} \cdot {v}_{k} \div {\sum }_{j = 1}^{M} {α}_{ji} {v}_{jk} , \qquad ( 6 )$$

where ai denotes row i of the matrix A=L_{[n]}⁻¹[n] and vk denotes column k of V[n]. Note that L[n]=V[n]VT[n]. Computing A is usually a relatively inexpensive operation, since the number of items in each training instance An is generally small for many recommendation applications.

To compute the second term of the derivative, we see that:

$$tr ( {L}_{\vert n \vert}^{- 1} \frac{\partial {L}_{\vert n \vert}}{\partial {v}_{ik}} ) = {a}_{i} \cdot {v}_{k} + {\sum }_{j = 1}^{M} {a}_{ji} {v}_{jk} \qquad ( 7 )$$

where bi denotes row i of the matrix B=Im−V(Ik+VTV)−1VT. Computing B is a relatively inexpensive operation, since we are inverting a K×K matrix with cost O(K3), and K (the number of latent trait dimensions) is usually set to a small value.

### Stochastic Gradient Ascent

We implement stochastic gradient ascent with a form of momentum known as Nesterov's Accelerated Gradient (NAG):

Wt+1=_βWt+(1−β)*∇f(Vt+βWt) (8)

Vt+1=Vt+Wt+1 (9)

where W accumulates the gradients, _ε>0 is the learning rate, _β∈[0; 1] is the momentum/NAG coefficient, and ∇f(V+βWt) is the gradient at V+βWt.

We use the following schedule for annealing the learning rate:

$${ε}_{t} = \frac{{ε}_{0}}{1 + t / T} \qquad ( 10 )$$

where ε0 is the initial learning rate, t is the iteration counter, and T is the number of iterations for which ε should be kept nearly constant. This serves to keep ε nearly constant for the first T training iterations, which allows the algorithm to find the general location of the local maximum, and then anneals ε at a slow rate that is known from theory to guarantee convergence to a local maximum. In practice, we set T so that ε is held nearly fixed until the iteration just before the test log-likelihood begins to decrease, which indicates that we have likely jumped past the local maximum. We find that setting β=0:95 and ε0=1:0×10-5 works well for the datasets used in testing. Instead of computing the gradient using a single training instance for each iteration, we compute the gradient using more than one training instance, called a mini-batch. We find that a mini-batch size of 1000 instances works well in practice.

### Regularization

We add a quadratic regularization term to the log-likelihood, based on item popularity, to discourage large parameter values and avoid overfitting. Since not all items in the item catalog are purchased with the same frequency, we encode prior assumptions into the regularizer. The motivation for using item popularity in the regularizer is that the magnitude of the K-dimensional item vector can be interpreted as the popularity of the item.

$$f ( V ) = {\sum }_{n = 1}^{N} log det ( L [ n ] ) - N l og det ( L + I ) - \frac{α}{2} {\sum }_{i = 1}^{M} λ i {\vert vi \vert}^{2} \qquad ( 11 )$$

where vi is the row vector from V for item i, and λi is an element from a vector λ whose elements are inversely proportional to item popularity,

$$λ = ( \frac{1}{C ( 1 )} , \frac{1}{C ( 2 )} , … , \frac{1}{C ( n )} ) , \qquad ( 12 )$$

where C(i) is the number of occurrences of item i in the training data.

Taking the derivative of each term of the log-likelihood with the regularization term, we now have:

$$\begin{matrix}\frac{\partial f}{\partial {v}_{ik}} = {\sum }_{n : i ∈ [ n ]} \frac{\partial }{\partial {v}_{ik}} ( log det ( {L}_{[ n ]} ) ) - N \frac{\partial }{\partial {v}_{ik}} ( log det ( L + I ) ) - \\ \frac{α}{2} {\sum }_{i = 1}^{M} {λ}_{i} \frac{\partial }{\partial {v}_{ik}} ( {‖ {v}_{i} ‖}^{2} ) \\ = {\sum }_{n : i ∈ [ n ]} tr ( {L}_{[ n ]}^{- 1} \frac{\partial {L}_{[ n ]}}{\partial {v}_{ik}} ) - Ntr ( {( L + I )}^{- 1} \frac{\partial ( L + I )}{\partial {v}_{ik}} ) - {αλ}_{i} {v}_{ik} .\end{matrix}$$

### Predictions

We seek to compute singleton next-item predictions, given a set of observed items. An example of this class of problem is basket completion, where we seek to compute predictions for the next item that should be added to shopping basket, given a set of items already present in the basket.

We use a k-DPP to compute next-item predictions. A k-DPP is a distribution over all subsets Y ε y with cardinality k, where Y is the ground set, or the set of all items in the item catalog. Next item predictions are done via a conditional density. We compute the probability of the observed basket A, consisting of k items. For each possible item to be recommended, given the basket, the basket is enlarged with the new item to k+1 items. For the new item, we determine the probability of the new set of k+1 items, given that k items are already in the basket. This machinery is also applicable when recommending a set B, which may contain more than one added item, to the basket.

A k-DPP is obtained by conditioning a standard DPP on the event that the set Y, a random set drawn according to the DPP, has cardinality k. Formally, for the k-DPP Pk we have:

$${P}^{k} ( Y ) = \frac{det ( LY )}{{\sum }_{{y}^{′} = k} det ( {L}_{{y}^{′}} )} \qquad ( 13 )$$

where |Y|=k. The normalizer sums only over sets that have cardinality k.

We can condition a k-DPP on the event that all of the elements in a set A are observed. We use LA to denote the kernel matrix for this conditional k-DPP, and the same notation is used for the conditional kernel of the corresponding DPP, since the kernels are the same. We may then show hereinbelow how to efficiently compute the conditional kernel. For a set B not intersecting with A, where |A|+|B|=k we have:

$$\begin{matrix}{P}^{k} ( Y = A ⋃ B \vert A ⊆ Y ) ∝ {P}_{L}^{k} ( Y = A ⋃ B ) & ( 14 ) \\ ∝ P ( Y = A ⋃ B ) & ( 15 ) \\ ∝ det ( {L}_{B}^{A} ) & ( 16 )\end{matrix}$$

where B is a singleton set containing the possible next item for which we would like to compute a predictive probability.

L_{B}^{A} denotes the principal submatrix of LA indexed by the items in B.

The kernel matrix LA for a conditional DPP is:

L^{A}=([(L+I_{Ā)}⁻¹]_{Ā)}⁻¹−I (18)

where [(L+I_{Ā)}⁻¹]_{Ā} is the restriction of (L+I_{Ā)}⁻¹ to the rows and columns indexed by elements in Y-A, and I_{Ā} is the matrix with ones in the diagonal entries indexed by elements of Y-A and zeroes everywhere else.

The normalization constant for equation 17 is:

$${Z}_{k - \vert A \vert}^{A} = {\sum }_{{\vert {y}^{′} \vert = k - \vert A \vert}_{A ⋂ {y}^{′} = 0}} det ( {L}_{{y}^{′}}^{A} ) \qquad ( 19 )$$

where the sum runs over all sets Y′ of size k-|A| that are disjoint from A. How can we compute it analytically?

We see that:

$$Zk = {\sum }_{\vert {Y}^{′} \vert = k} det ( {LY}^{′} ) = ek ( λ1 , λ2 , … , λ M ) \qquad ( 20 )$$

where λ1, λ2, . . . , λM are the eigenvalues of L and ek λ1, λ2, . . . , λM is the kth elementary symmetric polynomial on λ1, λ2, . . . , λM.

Therefore, to compute the conditional probability for a single item b in singleton set B, given the appearance of items in a set A, we have:

$$\begin{matrix}{P}_{L}^{k} ( Y = A ⋃ B \vert A ⊆ Y ) = \frac{det ( {L}_{B}^{A} )}{{Z}_{k - \vert A \vert}^{A}} & ( 21 ) \\ = \frac{{L}_{bb}^{A}}{{Z}_{1}^{A}} & ( 22 )\end{matrix} \begin{matrix}\frac{{L}_{bb}^{A}}{{e}_{1} ( {λ}_{1}^{A} , {λ}_{2}^{A} , … , {λ}_{M}^{A} )} & ( 23 )\end{matrix}$$

where _(λ₁^{A},λ₂^{A}, . . . , λ_{M}^{A}) are the eigenvalues of LA and el (λ₁^{A},λ₂^{A}, . . . , λ_{M}^{A}) is the first elementary symmetric polynomial on these eigenvalues.

### Efficient DPP Conditioning

The conditional probability used for prediction, and hence set recommendation or basket completion, uses LA in equation 18, which requires two inversions of large matrices. These are expensive operations, particularly for a large item catalog (large M). In this section we describe a way to efficiently condition the DPP L kernel that is enabled by a low-rank factorization of L.

For a DPP with kernel L, the conditional kernel LA with minors satisfying:

$$P ( Y = Y ⋃ A \vert A ⊆ Y ) = \frac{det ( {L}_{Y}^{A} )}{det ( LA + I )} \qquad ( 24 )$$

on Y ⊂ Y\A, can be computed from L by the rank-|A| update:

L^{A}=L_{Ā}−L_{Ā,A}L_{A}⁻¹L_{A,Ā} (25)

where L_{Ā,A} consists of the |A| rows and A columns of L.

Substituting V into equation 25 gives:

VĀ_Z^{A}V_{Ā}^{T} (26)

where:

Z^{A}=I−V_{A}^{T}(VAV_{A}^{T})⁻¹VA: (27)

ZA is a projection matrix, and is thus idempotent: ZA=(ZA)2. Since ZA is also symmetric, we have ZA=(ZA)T, and substituting ZA=ZA(ZA)T into (27) yields:

L^{A}=VĀZ^{A}(Z^{A})^{T}V_{Ā}^{T} (28)

=V^{A}(V^{A})^{T} (29)

where:

V^{A}=VĀZ^{A} (30)

Conditioning the DPP using equation 30 requires computing the inverse of a |A|×|A| matrix, as shown in equation 28, which is O(A3). This is much less expensive than the matrix inversions in equation 18 when |A|<<M, which we expect for most recommendation applications. For example, in online shopping applications, the size of a shopping basket (|A|) is generally far smaller than the size of the item catalog (M).

According to the present embodiments there are thus provided a method and system of basket completion for items contained in a catalog, the method carried out on an electronic processor, and comprising describing items of the catalog in terms of multiple parameters of a parameter space, embedding the items in the parameter space as vectors, each vector based on respective parameters; accepting an initial selection of one or more items; selecting as a second item to complement items already selected, another item within the parameter space whose vector forms a largest area when combined in a matrix with the vectors of the items already selected; and outputting to the user at least the second item to complete a basket with the items already selected.

In an embodiment, the describing of each item in terms of parameters is carried out in a learning phase, and the accepting and the selecting are part of a subsequent use phase which makes use of the parameter space and the items embedded therein from the learning phase.

In an embodiment, the learning phase further comprises selecting the parameters to provide numerical values suitable for differentially describing items in the catalog.

In an embodiment, the learning phase comprises, for each item, placing values for each parameter into a matrix and updating the matrix based on user activity. Initially seed values are placed and then the learning phase may optimize the seed values within the matrix to describe available sets of the items.

An embodiment may reoptimize the matrix during the use phase.

In an embodiment, the largest area indicating the most likely set completion is obtained by calculating a determinant of a matrix formed by vectors of the items already selected and the candidate item.

An embodiment may calculate the parameters within the parameter space using the determinantal point process and subsequently use those parameters for calculating the largest area. The user may select one or multiple items before basket completion is applied.

Certain features of the examples described herein, which are, for clarity, described in the context of separate embodiments, may also be provided in combination in a single embodiment. Conversely, various features of the examples described herein, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

What is claimed is:

1. A method of basket completion for items contained in a catalog, the method carried out on an electronic processor, the method comprising:
describing items of the catalog in terms of a plurality of parameters of a parameter space;
embedding the items in the parameter space as vectors, each vector based on respective parameters;
accepting a selection of a first at least one item;
selecting as a second item to complement the first at least one item, another item within the parameter space whose vector forms a largest area when combined with the vector of the first at least one item; and
outputting to the user at least the second item to complete a basket with the first at least one item.

2. The method of claim 1, wherein the describing each item is carried out in a learning phase, and wherein the accepting and the selecting are part of a subsequent use phase using the parameter space and the items embedded therein from the learning phase.

3. The method of claim 2, wherein the learning phase further comprises selecting the plurality of parameters to provide numerical values suitable for differentially describing items of the plurality of items.

4. The method of claim 3, wherein the learning phase comprises, for each item, placing values for each parameter into a matrix and updating the matrix based on user activity.

5. The method of claim 4, wherein the values for each item for each parameter being placed in the matrix comprise seed values.

6. The method of claim 5, wherein the learning phase comprises optimizing the seed values within the matrix to describe available sets of the items.

7. The method of claim 6, further comprising reoptimizing the matrix during the use phase.

8. The method of claim 1, wherein the largest area is obtained by calculating a determinant of a matrix formed by vectors of the first at least one item and the second item.

9. The method of claim 1, comprising calculating the parameters within the parameter space and subsequently calculating the largest area using a determinantal point process.

10. The method of claim 1, wherein the first at least one item comprises a plurality of items.

11. A system for basket completion for items contained in a catalog, the system implemented over an electronic network using an electronic processor, the system comprising:
the catalog of items;
a parameter space in which items of the catalog are described as vectors in terms of a plurality of parameters;
a user input for accepting a selection of a first at least one item;
a selector configured to select, as a second item to complement the first at least one item, another item within the parameter space whose vector forms a largest area when combined with the vector of the first at least one item; and
an output configured to output to the user at least the second item to complete a basket with the first at least one item.

12. The system of claim 11, further comprising a learning unit and a use unit, wherein the describing each item is carried out by the learning unit, and wherein the user input, the selector and the output are part of the use unit, the use unit being configured to obtain the vectors from the learning unit.

13. The system of claim 12, wherein the learning unit is configured to provide numerical values suitable for differentially describing items of the catalog items over the course of a learning phase.

14. The system of claim 13, wherein the learning phase comprises, for each item, placing values for each parameter into a matrix and updating the matrix based on user activity.

15. The system of claim 14, wherein the values for each item for each parameter being placed in the matrix comprise seed values.

16. The system of claim 15, wherein the learning phase comprises optimizing the seed values within the matrix to describe available sets of the items.

17. The system of claim 16, wherein the use unit is configured to reoptimize the matrix during a use phase, the use phase being subsequent to the learning phase.

18. The system of claim 11, wherein the selector is configured to obtain the largest area by calculating a determinant of an item matrix formed by vectors of the first at least one item and the second item.

19. The system of claim 11, wherein the learning unit is configured to calculate the parameters within the parameter space using a determinantal point process, and the use unit is configured to calculate the largest area using the parameters obtained from the determinantal point process.

20. The system of claim 11, wherein the first at least one item comprises a plurality of items.
